(19) United States
(12) Patent Application Publication
(10) Pub. No.: US 2012/0251420 A1
(43) Pub. Date: Oct. 4, 2012

(54) REMOVAL OF CO<sb>2</sb> FROM GASES HAVING LOW CO<sb>2</sb> PARTIAL PRESSURES, USING 2,2'-(ETHYLENEDIOXY)-BIS-(ETHYLAMINE) (EDEA)

(75) Inventors: Johannes Menzel, Waltrop (DE); Olaf Von Morstein, Essen (DE)

(73) Assignee: THYSSENKRUPP UHDE GMBH, Dortmund (DE)

(21) Appl. No.: 13/515,366

(22) PCT Filed: Dec. 21, 2010
(86) PCT No.: PCT/EP10/07841

§ 371 Date: Jun. 12, 2012

(30) Foreign Application Priority Data
Jan. 5, 2010 (DE) 10 2010 004 071.1

(51) Int. Cl. B01D 53/14

(52) U.S. Cl. 423/228

(57) ABSTRACT

A method of removing acid gases from a fluid flow, using an absorption agent comprising an aqueous solution of 2,2′-(ethylenedioxy)-bis-(ethylamine).

The invention relates to the use of an absorbent for the purpose of removing CO₂ from technical gases.

The removal of CO₂ from technical gases is of special importance with regard to the reduction of CO₂ emissions, with CO₂ being considered the main cause of the greenhouse effect.

Industry often uses aqueous solutions of organic bases such as alkanolamines, for example, as absorbents for the removal of acid-gas components.

The absorbent is regenerated by supplying heat, depressurising or stripping by means of suitable auxiliary agents. Once the absorbent has been regenerated, it can be reused as a regenerated solvent in the absorption of acid-gas components.

Flue gases from the combustion of fossil fuels are obtained at approximately atmospheric pressure. As the CO₂ content in the flue gases is typically around 3 to 13 vol. %, the CO₂ partial pressure ranges correspondingly between only 0.03 and 0.13 bar. To achieve an adequate removal of CO₂ from the flue gases at such low CO₂ partial pressures, a suitable absorbent is to have a very high CO₂ binding capability. In particular, highest possible absorption capacity should also be ensured already at low CO₂ partial pressures.

The absorption capacity of the absorbent largely determines the required circulation flow rate of the absorbent and thus the size and cost of the necessary equipment. As the energy required for heating and cooling the absorbent is proportional to the circulation flow rate, the regeneration energy required for regenerating the solvent will decrease to a significant degree if the circulation flow rate of the absorbent can successfully be reduced.

Beside a high absorption capacity, however, a suitable absorbent should in particular also have as high a stability towards oxygen as possible, as there is always a certain content of oxygen particularly in flue gases. As known from literature, many amine compounds which are normally characterised by favourable absorption properties decompose easily in the presence of oxygen, which will result in a high absorbent consumption on the one hand and to correspondingly high costs on the other hand.

The decomposition products obtained will generally produce a considerably increased level of corrosion and in addition a significantly reduced capacity of the absorbent.

Volatile decomposition products such as ammonia, for example, would cause a contamination of the CO₂ product and the flue gas leaving the CO₂ scrubber with unpermitted emission components. To avoid such emissions, it will be necessary to add further process steps, which will increase the cost of a CO₂ scrubber even further.

In US 2009/0199709 A1 for example the use of an absorbent for removing acidic gases from a fluid stream is known, said absorbent comprising an aqueous amine solution. A multiplicity of examples are given of possible amine solutions, but no suggestion to use 2,2′-(ethylenedioxy)bis(ethylamine).

In US 2008/0125314 A1 as well the use of an absorbent for removing carbon dioxide from a fluid stream is known. Here, 2,2′-(ethylenedioxy)bis(ethylamine) may be present. There must, though, be a second component, likewise an amine solution, present. The use of an aqueous 2,2′-(ethylenedioxy)bis(ethylamine) solution without another component is not suggested.

Hence there is a significant demand for an alternative absorbent which, on the one hand, has as high a CO₂ absorption capacity as possible at low partial pressures, and which is at the same time as stable towards oxygen as possible and also thermally stable under absorbent regeneration conditions. To meet such demand, i.e. to make such an absorbent available, and to provide such a method for the removal of CO₂ from technical gases, are the aims of the present invention.

The aim is achieved by the use of an absorbent consisting of 2,2′-(ethylene-dioxy)bis(ethylamine) (EDEA) in aqueous solution.

The absorbent to be used generally contains 10 to 90 wt. %, preferably 30 to 65 wt. % EDEA with reference to the weight of the absorbent.

In an embodiment of the invention the absorbent to be used also contains at least one more amine different from 2,2′-(ethylene-dioxy)bis(ethylamine). Thus the absorbent according to the invention may, for example, contain 5 to 45 wt. %, preferably 10 to 40 wt. % of one or more different amines.

The at least one more amine different from 2,2′-(ethylenedioxy)bis-(ethylamine) is, for example, selected from:

A) tertiary amines of the general formula:

N(R1)₂₋ₙ(R2)₁₊ₙ

in which R1 represents an alkyl group and R2 a hydroxyalkyl group

or

tertiary amines of the general formula:

(R1)₂₋ₙ(R2)ₙN—X—N(R1)₂₋ₘ(R2)ₘ

in which R1 represents an alkyl group, R2 a hydroxyalkyl group, X an alkylene group, which is interrupted by oxygen once or several times, and n and m an integer from 0 to 2, or two remainders R1 and R2 bound to different nitrogen atoms together representing an alkylene group,

B) sterically hindered amines,

C) 5, 6, or 7-membered saturated heterocyclic compounds with at least one NH-group in the ring, which may have one or two more heteroatoms selected from nitrogen and oxygen in the ring,

D) primary or secondary alkanolamines,

E) alkylene diamines of the formula:

H₂N—R2-NH₂

in which R2 represents a C₂ to C₆ alkyl group.

In a preferential embodiment of the invention the tertiary amines which are used in addition to 2,2′-(ethylenedioxy)bis(ethylamine) are selected from a group comprising tris(2-hydroxyethyl)amine, tris(2-hydroxypropyl)amine, tributanolamine, bis(2-hydroxyethyl)-methylamine, 2-diethylaminoethanol, 2-dimethylaminoethanol, 3-dimethylamino-1-propanol, 3-diethylamino-1-propanol, 2-diisopropylaminoethanol, N,N-bis(2-hydroxypropyl)methylamine (methyldiisopropanolamine, MDIPA), N,N,N′,N′-tetramethylethylene diamine, N,N-diethyl-N′,N′-dimethylethylene diamine, N,N,N′,N′-tetraethylethylene diamine, N,N,N′,N′-tetramethylpropane diamine, N,N,N′,N′-tetraethylpropane diamine, N,N-dimethyl-N′,N′-diethylethylene diamine, 2-(2-dimethylaminoethoxy)-N,N-dimethyl ethane amine; 1,4-diazabicyclo[2.2.2]octane (DABCO); N,N,N′-trimethylaminoethyl ethanol amine, N,N′-dimethyl piperazine and N,N′-bis(hydroxyethyl) piperazine. The compound bis-dimethylaminoethyl ether is used with particular preference. Further potential tertiary amines are disclosed in WO 2008/145658 A1, U.S. Pat. No. 4,217,236 and US 2009/0199713 A1.

In a further embodiment the sterically hindered amines which are used in addition to 2,2′-(ethylenedioxy)bis(ethylamine) are selected from a group comprising 2-amino-2-methyl-1-propanol, 2-amino-2-methyl-1-butanol, 3-amino-3-methyl-1-butanol, 3-amino-3-methyl-2-pentanol and 1-amino-2-methylpropane-2-ol. Other sterically hindered amines that can be used are mentioned in WO 2008/145658 A1, U.S. Pat. No. 4,217,236, US 2009/0199713 A1, U.S. Pat. No. 5,700,437, U.S. Pat. No. 6,500,397 B1 and U.S. Pat. No. 6,036,931.

Optionally, the 5, 6, or 7-membered saturated heterocyclic compounds which are used in addition to 2,2′-(ethylenedioxy)bis(ethylamine) are selected from a group comprising piperazine, 2-methyl piperazine, N-methyl piperazine, N-ethyl piperazine, N-aminoethyl piperazine, homopiperazine, piperidine and morpholine. The compound piperazine is used with particular preference. Other compounds that can be used are described in WO 2008/145658 A1 and US 2009/0199713 A1.

The primary or secondary alkanolamines which are used in addition to 2,2′-(ethylenedioxy)bis(ethylamine) are advantageously selected from a group comprising 2-amino ethanol, N,N-bis(2-hydroxyethyl)amine, N,N-bis(2-hydroxypropyl)amine, 2-(methylamino)ethanol, 2-(ethylamino)ethanol, 2-(n-butylamino)ethanol, 2-amino-1-butanol, 3-amino-1-propanol and 5-amino-1-pentanol. Other potential compounds are again disclosed in documents WO 2008/145658 A1 and US 2009/0199713 A1.

In a further embodiment of the invention the alkyl diamines which are used in addition to 2,2′-(ethylenedioxy)bis(ethylamine) are selected from a group comprising hexamethylene diamine, 1,4-diaminobutane, 1,3-diaminopropane, 2,2-dimethyl-1,3-diaminopropane, 3-methylaminopropylamine, 3-(dimethylamino)propylamine, 3-(diethylamino)propylamine, 4-dimethylaminobutylamine and 5-dimethylaminopentylamine, 1,1,N,N-tetramethylethanediamine, 2,2,N,N-tetramethyl-1,3-propane diamine, N,N′-dimethyl-1,3-propane diamine, N,N′bis(2-hydroxyethyl)ethylene diamine. In addition, all components can be used that are identified accordingly in WO 2008/145658 A1 and US 2009/0199713 A1.

Furthermore the use of the absorbent is characterised by the feature that the fluid stream is brought into contact with one of the before-specified absorbents, the absorbent thus being laden with CO₂. This takes place preferentially at a partial pressure of <200 mbar.

The laden absorbent is advantageously regenerated by heating, depressurising, stripping with stripping vapours produced by internal evaporation of the solvent, stripping with an inert fluid or by a combination of two or all of these measures.

The present invention is described below in more detail by means of two examples.

### EXAMPLE 1

### Testing Stability Towards Oxygen

The stability of 2,2′-(ethylenedioxy)bis(ethylamine) towards the action of oxygen was determined as follows:

The analyses were carried out in a glass apparatus consisting of round-bottom flasks and reflux condensers. The amines were weighed in. An air flow of approx. 12 NI air/hour, pre-saturated with water vapour, was bubbled into the stirred solution at approx. 110° C. over a period of 4 days. To follow up the course of the reaction, daily samples were analysed by gas-chromatography and acid/base titration (0.1 molar hydrochloric acid) to determine the absolute amine content. At the end the flasks were weigh-checked in order to determine the total amount of the solution.

As a result of the pre-saturation of the air with water vapour there was an increase in weight in the flask over the test period. Once the test result had been corrected by the weight increase resulting from the introduced water, it was determined after the completion of the test that 96.2% of EDEA used (50 wt. %) were still contained in the solution. This corresponds to a solvent loss of 3.8% of the EDEA used. Correspondingly there were also only minor colour changes from yellow to light orange over this period.

In contrast to this, the stability test of a monoethanolamine solution (MEA) of also approx. 50 wt. % strength resulted in a final concentration of 44.89 wt. % MEA after 4 days, all other conditions being the same. This corresponds to a solvent loss of approx. 9% of the MEA used during the test period. Correspondingly the colour changed from slightly beige to dark orange. Hence the amine suggested here has a 2.4 times higher stability towards oxygen than MEA.

### EXAMPLE 2

### Determining CO₂ Absorption Capacity

A static phase equilibrium apparatus was used to measure the synthetic gas solubility (isothermal P-x data) by the synthetic measuring principle. In this assembly the pressure is measured for different gross compositions of a mixture at constant temperature. The thermostated, purified and degassed solvent is pumped into an evacuated and thermostated measuring cell by means of metering pumps which allow minor differences in volume to be demonstrated. Subsequently the gas is added in small portions. The CO₂ then contained in the absorption solution at a defined pressure is calculated under consideration of the gas space.

The CO₂ absorption for a CO₂ partial pressure of 0.1 bar was determined at temperatures of 40° C. and 120° C. The cyclic absorption capacity is equal to the load difference at 40° C. and 120° C.

TABLE 1

| | Relative cyclic absorption |
|---|---|
| Absorbent | capacity in % |
| MEA (30 wt. %) | 100 |
| EDEA (30 wt. %) | 107 |

The results according to table 1 show that the cyclic absorption capacity of a 30 wt. % EDEA solution is approx. 1.05 times higher than that of a 30 wt. % MEA solution. In the case of solvent concentrations greater than or equal to 50 wt. % EDEA which may also be used for the CO₂ absorption, the results gave a cyclic absorption capacity which was 1.8 times higher than that of a 30 wt. % MEA solution. As the corrosiveness of MEA solutions of more than 30 wt. % MEA in the aqueous solution sharply increases, MEA solutions of more than 30 wt. % MEA have not yet been used for technical applications.

Hence the invention provides a solvent for the absorption of CO₂, especially in the range of low CO₂ partial pressures and in the presence of oxygen, which is significantly more stable under these conditions on the one hand and also has a higher cyclic absorption capacity on the other hand than a comparable solvent according to the state of the art. This proves the specific suitability of the amine according to the invention for the removal of CO₂ from technical gases of low partial pressures (<200 mbar).

1. Use of an absorbent for the removal of acid gases from a fluid stream, with the absorbent consisting of an aqueous solution of 2,2′-(ethylenedioxy)bis-(ethylamine).

2. Use of an absorbent according to claim 1, with the absorbent containing 10 to 90%, preferably 30 to 65%, 2,2′-(ethylenedioxy)bis(ethylamine) with reference to the weight of the absorbent.

3. Use of an absorbent according to claim 1 or 2, with the absorbent containing at least one more amine different from 2,2′-(ethylenedioxy)bis(ethylamine).

4. Use of an absorbent according to claim 3, with the absorbent containing 5 to 45% and preferably 10 to 40% of the at least one amine different from 2,2′-(ethylenedioxy)bis(ethylamine).

5. Use of an absorbent according to claim 3 or 4, with the at least one more amine different from 2,2′-(ethylenedioxy)bis(ethylamine) being selected from:
A) tertiary amines of the general formula:
N(R1)₂₋ₙ(R2)₁₊ₙ
in which R1 represents an alkyl group and R2 a hydroxyalkyl group
or
tertiary amines of the general formula:
(R1)₂₋ₙ(R2)ₙN—X—N(R1)₂₋ₘ(R2)ₘ
in which R1 represents an alkyl group, R2 a hydroxyalkyl group, X an alkylene group, which is interrupted by oxygen once or several times, and n and m an integer from 0 to 2, or two remainders R1 and R2 bound to different nitrogen atoms together representing an alkylene group,
B) sterically hindered amines,
C) 5, 6, or 7-membered saturated heterocyclic compounds with at least one NH-group in the ring, which may have one or two more heteroatoms selected from nitrogen and oxygen in the ring,
D) primary or secondary alkanolamines,
E) alkylene diamines of the formula:
H₂N—R2-NH₂
in which R2 represents a C₂ to C₆ alkyl group.

6. Use of an absorbent according to claim 5, with the tertiary amine being selected from a group comprising bis-dimethylaminoethyl ether, tris(2-hydroxyethyl)amine, tris(2-hydroxypropyl)amine, tributanolamine, bis(2-hydroxyethyl)-methylamine, 2-diethylaminoethanol, 2-dimethylaminoethanol, 3-dimethylamino-1-propanol, 3-diethylamino-1-propanol, 2-diisopropylaminoethanol, N,N-bis(2-hydroxypropyl)-methylamine (methyldiisopropanolamine, MDIPA), N,N,N′,N′-tetramethyl-ethylene diamine, N,N-diethyl-N′,N′-dimethylethylene diamine, N,N,N′,N′-tetraethylethylene diamine, N,N,N′,N′-tetramethylpropane diamine, N,N,N′,N′-tetraethylpropane diamine, N,N-dimethyl-N′,N′-diethylethylene diamine, 2-(2-dimethylaminoethoxy)-N,N-dimethyl ethane amine; 1,4-diazabicyclo-[2.2.2]octane (DABCO); N,N,N′-trimethylaminoethyl ethanol amine, N,N′-dimethyl piperazine and N,N′-bis(hydroxyethyl) piperazine, with bis-dimethylaminoethyl ether being used with particular preference.

7. Use of an absorbent according to claim 5, with the sterically hindered amine being selected from a group comprising 2-amino-2-methyl-1-propanol, 2-amino-2-methyl-1-butanol, 3-amino-3-methyl-1-butanol, 3-amino-3-methyl-2-pentanol and 1-amino-2-methylpropane-2-ol.

8. Use of an absorbent according to claim 5, with the 5, 6, or 7-membered saturated heterocyclic compounds being selected from a group comprising piperazine, 2-methyl piperazine, N-methyl piperazine, N-ethyl piperazine, N-aminoethyl piperazine, homopiperazine, piperidine and morpholine, with piperazine being used with particular preference.

9. Use of an absorbent according to claim 5, with the primary or secondary alkanoamines being selected from a group comprising 2-amino ethanol, N,N-bis(2-hydroxyethyl)amine, N,N-bis(2-hydroxypropyl)amine, 2-(methylamino)ethanol, 2-(ethylamino)ethanol, 2-(n-butylamino)ethanol, 2-amino-1-butanol, 3-amino-1-propanol and 5-amino-1-pentanol.

10. Use of an absorbent according to claim 5, with the alkyl diamines being selected from a group comprising hexamethylene diamine, 1,4-diaminobutane, 1,3-diaminopropane, 2,2-dimethyl-1,3-diaminopropane, 3-methylamino-propylamine, 3-(dimethylamino)propylamine, 3-(diethylamino)propylamine, 4-dimethylaminobutylamine and 5-dimethylaminopentylamine, 1,1,N,N-tetramethylethanediamine, 2,2,N,N-tetramethyl-1,3-propane diamine, N,N′-dimethyl-1,3-propane diamine, N,N′bis(2-hydroxyethyl)ethylene diamine.

11. Use of an absorbent for the removal of carbon dioxide from a fluid stream according to one of claims 1 to 10, with the fluid stream being brought into contact with the absorbent and the absorbent being laden with CO₂.

12. Use of an absorbent for the removal of carbon dioxide from a fluid stream according to claim 11, with the absorbent being laden with CO₂ at a partial pressure <200 mbar.

13. Use of an absorbent for the removal of carbon dioxide from a fluid stream according to one of claims 1 to 12, with the laden absorbent being regenerated by
i) heating,
ii) depressurising,
iii) stripping with stripping vapours produced by internal evaporation of the solvent,
iv) stripping with an inert fluid
or by a combination of two or all of these measures
